(19) United States
(12) Patent Application Publication
(10) Pub. No.: US 2007/0273176 A1
(43) Pub. Date: Nov. 29, 2007

(54) Energy shuttle

(76) Inventor: Adil Shazad, London (GB)

Correspondence Address: ADIL SHAZAD, 5 STARPATH, NORTHOLT, MIDDLESEX, LONDON, UB5 6TQ, omitted

(21) Appl. No.: 11/438,522

(22) Filed: May 23, 2006

(51) Int. Cl. B62D 35/00

(52) U.S. Cl. 296/180.1

(57) ABSTRACT

A dome-shaped body 13 is removably fitted to the front license plate 12 of a motor vehicle to reduce air resistance and achieve fuel savings. The body 13 is preferably a hollow dome of transparent plastic. It may be fitted to the license plate 12 by posts 19 on the inside 18 of the dome that engage with slots 22 in mounting brackets 20 adhered to the license plate, whereby the mounting brackets 20 are concealed inside the dome 13 in use. A stabilizer plate 30 engages an edge of the body 13 to prevent accidental removal of the posts 19 from the slots 22.

### BACKGROUND OF THE INVENTION

The invention pertains to the field of improving the energy efficiency of motor vehicles such as automobiles, buses, trucks and motorcycles.

The front face of a vehicle often presents a flat, generally vertical surface that provides high wind resistance when the vehicle is moving and therefore reduces the aerodynamic efficiency of the vehicle and increases its fuel consumption, particularly at high speeds. Vehicle designers generally take this into account and design vehicles to be as streamlined as possible. However, most vehicles are required to display a front license plate (also known as a registration plate or number plate), which is a flat vertical plate at the very front of the vehicle and therefore adversely affects the fuel efficiency. Because vehicles are traded across international boundaries, even in countries that do not require a front license plate to be displayed most vehicles will still have a corresponding flat area to which a license plate could be fixed in other countries (and in the following parts of this specification references to a license plate should be taken to include a reference to such a corresponding flat area).

U.S. Pat. No. 6,006,459 (Kosmach), Canadian patent application 2,426,985 (Feng) and European patent application 0761504 (Fiat) all disclose transparent covers for fixing over automobile license plates. However, such covers are specific to the individual design of the front of the vehicle surrounding the license plate and, because they cover the whole area of the license plate, their front face is only slightly curved and their contribution to reducing wind resistance is small.

### BRIEF SUMMARY OF THE INVENTION

The present invention provides a device known as an energy shuttle for reducing the air resistance of a vehicle that can be fitted to any vehicle having a planar, forwardly-facing surface, such as a license plate. Preferably the device can be removed when desired. The device has a dome-shaped front surface that efficiently deflects air across the planar surface and significantly increases the fuel efficiency of the vehicle.

The invention also provides a motor vehicle incorporating the energy shuttle device; and a method of using the energy shuttle device to reduce the air resistance of a motor vehicle.

### BRIEF DESCRIPTION OF THE DRAWINGS

FIG. 1 is a perspective view of the front of an automobile, showing an energy shuttle device according to the invention attached to the license plate.

FIG. 2 is a front view of the energy shuttle device shown in FIG. 1.

FIG. 3 is a side view of the energy shuttle device shown in FIG. 1.

FIG. 4 is a plan view of the energy shuttle device shown in cross section on line A-A in FIG. 1.

FIG. 5A is an enlarged plan view of the right mounting bracket shown in FIG. 4.

FIG. 5B is an enlarged side view of the right mounting bracket shown in FIG. 4.

### DETAILED DESCRIPTION OF THE INVENTION

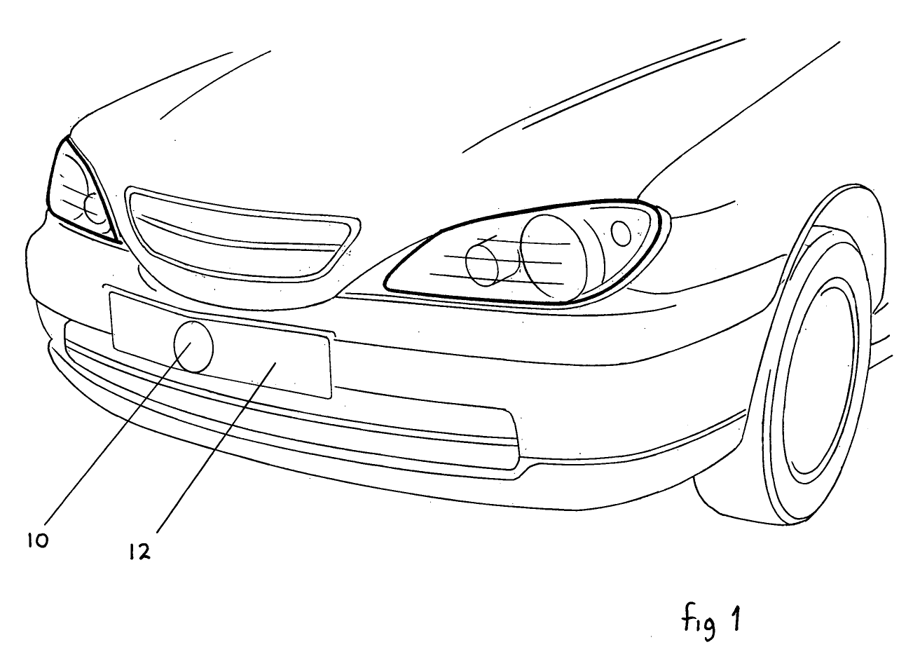

FIG. 1 shows an energy shuttle 10 attached to the centre of the front license plate 12 of an automobile. The energy shuttle 10 is circular in outline and is contained within the perimeter of the license plate 12.

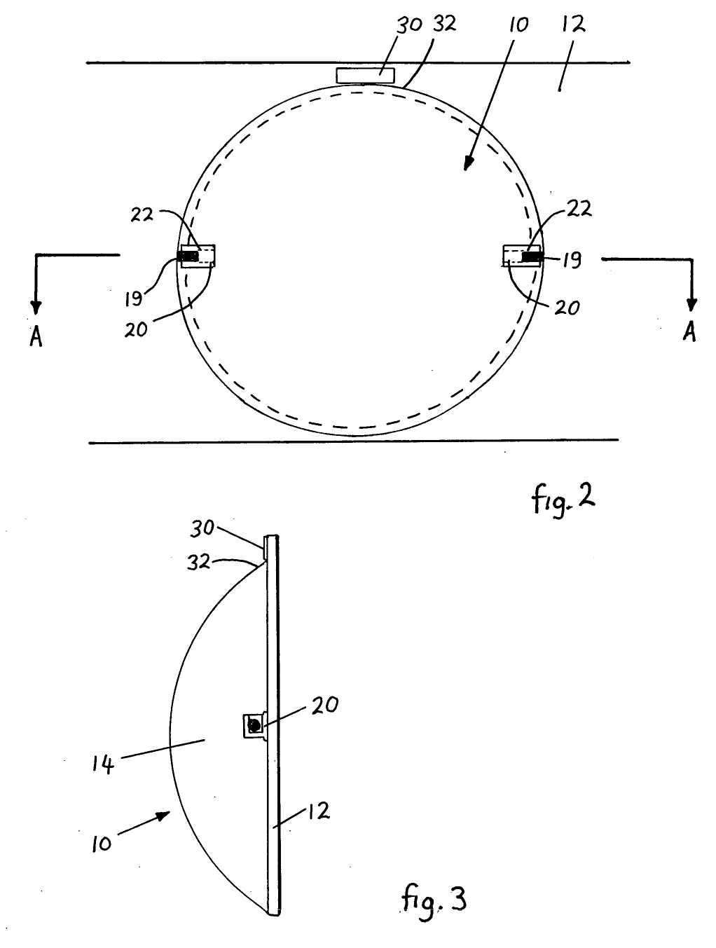

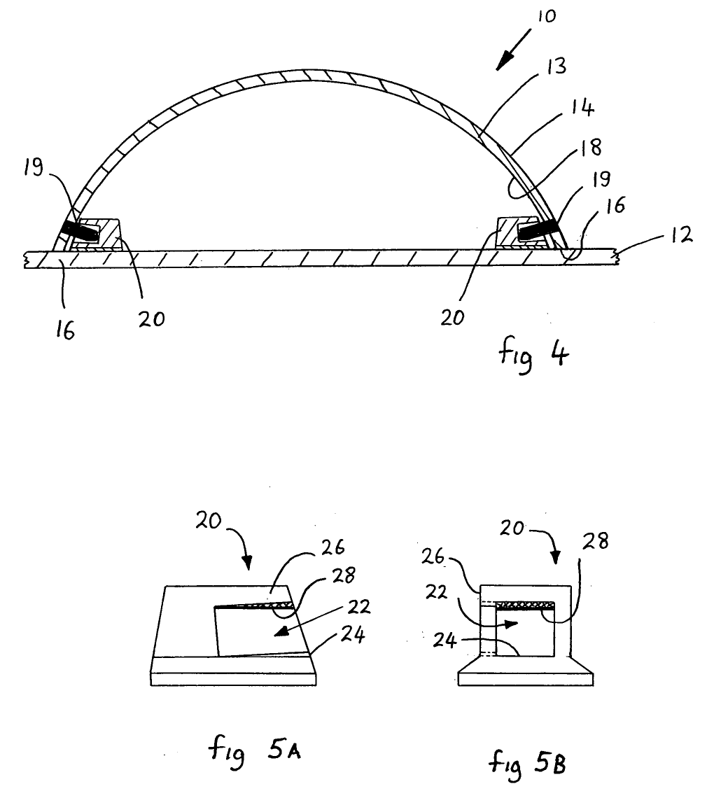

With reference to FIGS. 2, 3 and 4, the body 13 of the energy shuttle 10 is in the shape of a dome, having a convex front face 14, a planar rear face 16, and a concave inner face 18. The planar rear face 16 sits flush against the license plate 12. The front face 14 of the energy shuttle 10 as shown is in the form of a segment of a sphere. It would be possible to vary the depth of the segment so as to be less than shown or greater than shown (up to a hemisphere). The front face 14 could also adopt other domed shapes, such as a paraboloid, and it is not essential that the outline should be circular: for example an elliptical outline would be able to cover a greater area of an elongated license plate.

The body 13 of the energy shuttle 10 is made of a tough, highly transparent plastic material, through which the license plate 12 can easily be read.

At diametrically opposite positions on the body 13 of the energy shuttle 10, two posts 19 extend from the inner face 18 into the interior of the dome. As shown, the posts 19 are preferably angled slightly backwards towards the rear face 16.

The energy shuttle 10 is mounted to the license plate 12 via two mounting brackets 20, which are fixed to the license plate generally along its centreline, at a spacing just less than the diameter of the energy shuttle 10. The mounting brackets 20 are preferably adhered to the license plate 12 using double-sided adhesive tape, but other forms of mounting such as screws may alternatively be used. The mounting brackets 20 should be positioned so as not to obscure any numbers and letters on the license plate 12.

Each mounting bracket 20 has a slot 22 which is open to the outwardly-facing surface 24 and the upwardly-facing surface 26 of the bracket 20 (as it is oriented when in use). The slot 22 is adapted to receive one of the posts 19 of the body 13 and is preferably inclined at a matching angle to that of the posts 19. An upwardly facing inner surface of the slot 22 is coated with a layer 28 of resilient material such as rubber.

As shown most clearly in FIG. 2, when the two mounting brackets 20 are correctly fixed to the license plate 12, they present a pair of upwardly and outwardly facing slots 22 into which the posts 19 of the body 13 can be lowered so that the body 13 remains held by gravity with its rear face 16 flush against the license plate 12 and the mounting brackets 20 concealed within the dome, where they do not interfere with airflow.

The energy shuttle 10 further comprises a stabilizer 30, which is a thin, rectangular strip of plastic fixed close to the upper edge of the license plate 12, preferably by double-sided adhesive tape. As shown in FIG. 3, the stabilizer 30 engages an upper edge 32 of the body 13 of the energy shuttle when it is flush against the license plate 12 and prevents the body 13 from being lifted vertically to disengage the posts 19 from the slots 22 of the mounting brackets. Thus the energy shuttle 10 cannot be accidentally removed from the license plate 12 when the vehicle is driving at high speed. Preferably, the stabilizer is positioned such that the posts 19 of the body 13 must be pushed slightly into the resilient layers 28 in the slots 22 in order for the upper edge 32 of the body 13 to engage the stabilizer 30. Then the force of the resilient layers 28 acting on the posts 19 helps to hold the body 13 in engagement with the stabilizer 30.

To remove the energy shuttle 10 from the license plate 12, its upper edge 32 only needs to be unhooked from the thin stabilizer 30 and the body 13 can then be lifted away for replacement or storage.

It has been found by fitting an energy shuttle as illustrated to the license plates 12 of various models of automobile that fuel savings of 15 to 20% can be achieved in urban driving, with still greater savings in motorway driving.

1. An air resistance reduction device, comprising:
a body defining a dome-shaped front face and a planar rear face; and
mounting elements adapted for mounting the rear face of said body against a planar surface of a vehicle.

2. An air resistance reduction device according to claim 1, which is transparent.

3. An air resistance reduction device according to claim 1, wherein the mounting elements comprise:
a pair of mounting brackets for attachment to said planar surface of a vehicle, each bracket defining a slot; and
a pair of posts secured to said body and adapted to be removably received in the slots of the mounting brackets, whereby said body may be removably attached to said brackets.

4. An air resistance reduction device according to claim 3, wherein said body is in the form of a hollow dome further comprising a concave inner face surrounded by said planar rear face; and wherein said pair of posts project from said inner face.

5. An air resistance reduction device according to claim 3, wherein the mounting elements further comprise a stabilizer element for attachment to said planar surface of a vehicle and adapted to releasably engage an edge of said body.

6. An air resistance reduction device according to claim 5, wherein the slot of each said mounting bracket includes a resilient surface adapted to act on one of said posts that is received in the slot and thereby urge said body towards engagement with said stabilizer element.

7. An air resistance reduction device according to claim 1, wherein a cross-section of said body parallel to said planar rear face is circular in outline.

8. A motor vehicle comprising:
a forwardly facing planar surface; and
an air resistance reduction device comprising a body having a dome-shaped front face and having a planar rear face that is mounted on said planar surface of said vehicle.

9. A motor vehicle according to claim 8, wherein said planar surface is a vehicle license plate.

10. A motor vehicle according to claim 8, further comprising:
a pair of mounting brackets attached to said planar surface of said vehicle, each bracket defining a slot; and
a pair of posts secured to said body and removably received in the slots of the mounting brackets.

11. A motor vehicle according to claim 10, wherein said mounting brackets are attached to the planar surface of said vehicle by double-sided adhesive tape.

12. A motor vehicle according to claim 10, further comprising a stabilizer element attached to said planar surface of said vehicle and releasably engaging an edge of said body.

13. A method of reducing the air resistance of a motor vehicle comprising the step of attaching, to a forwardly-facing planar surface of said vehicle, a body that has a dome-shaped front face and a planar rear face.

14. A method of reducing the air resistance of a motor vehicle according to claim 13, wherein said planar surface is a vehicle license plate.
